(19) United States
(12) Patent Application Publication
(10) Pub. No.: US 2013/0036949 A1
(43) Pub. Date: Feb. 14, 2013

(54) Lapboard With Securing Mechanism For Computers And Other Electronic Devices

(71) Applicant: Lan Thi Hoang Nguyen, Delray Beach, FL (US)

(72) Inventor: Lan Thi Hoang Nguyen, Delray Beach, FL (US)

(21) Appl. No.: 13/209,426

(22) Filed: Aug. 14, 2011

(51) Int. Cl. A47B 37/00; B23P 11/00; A47B 23/00

(52) U.S. Cl. 108/6; 108/43; 29/428

(57) ABSTRACT

A lapboard with an adjustable retaining mechanism that secures a device, such as a laptop computer, a tablet computer, a smartphone, or an electronic game, each of which may have a different size. The retaining mechanism is movably attached to the lapboard such that it can be adjusted to accommodate devices of varying sizes. The retaining mechanism is positioned to prevent inadvertent movement of the laptop in relation to the lapboard. In addition an optional tilting mechanism allows the device to be held in a variety of angles for ease of viewing.

### BACKGROUND

1. Technical Field

This invention relates in general to a lapboard, and more particularly, it relates to a lapboard with a securing mechanism that prevents an object, such as a tablet computer, an iPad™, an iPhone™, an iPod™, an e-book reader (e.g. Kindle™), an electronic game, or a book from slipping off of the lapboard.

2. Background of the Invention

As personal computer technology advanced, the development of portable (i.e. laptop) computers provided users with substantial freedom as to where they could work. Laptops allow users to take their computers with them, whether at traditional locations such as work or at the office, or at non-traditional locations such as at home, or while traveling. A problem associated with using laptop computers is that they can be used in odd locations that create new problems not found in traditional work locations.

For example, when using a laptop computer at non-traditional locations, such as at home, the laptop is normally not placed in a stable location. Most often, the user will simply place the laptop on his or her lap. Of course, this can create new problems. For example, laptops can put off a substantial amount of heat that may be annoying to a user, they can be uncomfortable when resting directly on the user's legs, and they can be unstable because movements by the user may cause the laptop to fall with the potential for damage the laptop.

The prior art has attempted to address some of these issues. In regard to the issue of heat, the use of lapboards has greatly reduced the discomfort created by excessive heat generated by the laptop computer. Likewise, the use of pads on the bottom surface of lapboards has provided further heat insulation, as well as increasing comfort for the user.

For ease of discussion, the description of the prior art was couched in terms of laptop computers. However, those skilled in the art will recognize that the use of lapboards is not limited to laptop computers. Any small electronic device, such as laptop computers, tablet computers, iPads™, smart phones such as iPhones™, handheld devices such as iPods™, e-book readers such as the Kindle™, or electronic games can often be more conveniently used in conjunction with a lapboard. As a result, the discussion of the problems related to lapboards, while couched in terms of a laptop computer, apply to any of the aforementioned devices.

Unfortunately, while addressing some of the problems related to the use of laptops outside of a normal work environment, the prior art has failed to provide a method of avoiding damage to the laptop created by accidental slippage of the laptop off of the lapboard. It would be desirable to have a method of securing the laptop to a lapboard such that it would not accidentally fall from the lapboard due to movement by the user.

While the prior art has provided basic lapboards for the convenience of users, it has failed to provide an adjustable lapboard that can secure laptops of varying sizes, or other electronic devices, such that they are prevented from accidentally sliding off of the lapboard due to user movement.

### SUMMARY OF THE INVENTION

This invention provides a lapboard with adjustable retaining mechanisms that allow laptop computers, or other devices such as tablet computers, iPads™, smart phones such as iPhones™, handheld devices such as iPods™, e-book readers such as the Kindle™, or electronic games and other devices of varying sizes to be secured to the lapboard. The adjustable retaining mechanisms are movably mounted on the lapboard such that they can be adjusted to accommodate laptops of varying sizes. The retaining mechanisms are positioned to prevent longitudinal or lateral movement of the laptop in relation to the lapboard. The invention also provides an optional adjustable tilt mechanism to provide easy viewing for a user.

### BRIEF DESCRIPTION OF THE DRAWINGS

FIG. 1 is a top plan view of a prior art lapboard.

FIG. 2A is a top view of a preferred embodiment of the invention showing restraints that slide along a track in the surface the lapboard.

FIG. 2B is a side end view of a portion of lapboard further illustrating the slot along with lateral slot extensions.

FIG. 2C is a side view of a portion of a restraint illustrating the slot key that fits inside of the slot and lateral slot extensions and is held via friction.

FIG. 2D is a side view of a portion of a restraint illustrating the slot key that fits inside of the slot and lateral slot extensions and is held via a locking mechanism.

FIG. 2E is a side view of a portion of a restraint showing the slot key inserted inside the lateral slot extensions of slot and held via a locking mechanism.

FIG. 2F is a side view of another alternative preferred embodiment of the lapboard in which a raised rail on the surface of the lapboard replaces the slot in the previous embodiment.

FIG. 2G is a side view of another alternative preferred embodiment of the restraint in which a channel in the restraint is sized to slidably fit on the rail.

FIG. 3 is a top plan view of the preferred embodiment of FIG. 2 in which the lapboard shown in FIG. 2 in which a laptop computer is placed into position and secured.

FIG. 4 is a top plan view of an alternative preferred embodiment of the lapboard in which the restraints are reversed in orientation.

FIG. 5 is a top view of yet another preferred embodiment of invention in which the slot 16 is replaced by rail 17.

FIG. 6 is a top plan view of yet another preferred embodiment of the invention in which the upper surface of the lapboard is at least partially covered by hook and loop material.

FIG. 7 is a top plan view of the alternative preferred embodiment of FIG. 6 that shows a laptop computer secured to the lapboard.

FIG. 8A is a top plan view of alternative preferred embodiment that shows an optional cutout for receiving a tilting bracket.

FIG. 8B illustrates the alternative preferred embodiment of FIG. 8A with the tilting bracket installed and in a flat position.

FIG. 8C illustrates the alternative preferred embodiment of FIG. 8A with the tilting bracket installed and in a raised position for supporting an electronic device.

### DETAILED DESCRIPTION OF THE PREFERRED EMBODIMENT

Prior to a discussion of the figures, an overview of the invention will be presented. The invention provides an improved lapboard that prevents unwanted longitudinal or lateral movement of the laptop computer resting on the lapboard. Typically, laptop computers are held in place on the lapboard by gravity and friction. Unfortunately, during the course of use, a user may make sudden movements due to external events. When this happens, it is possible for the laptop computer to slide either longitudinally or laterally and fall off of the lapboard causing damage to the computer that may require expensive repairs.

Many prior art lapboards also provide padding (not shown) on the lower surface of the lapboard for user comfort.

The invention provides a lapboard that has physical restraints to prevent longitudinal or lateral motion of the laptop computer in relation to the lapboard. While it is possible to have fixed restraints for a laptop having a particular size, the preferred embodiment uses adjustable restraints to allow a single lapboard to accommodate a variety of laptop sizes. Currently, the majority of laptops vary in size based on the size of the monitor used that particular laptop. Commercially available laptop computers have typical monitors that range in size from 11 to 17 inches diagonally. In addition, there are some commercially available laptops that have screen diameters up to 21 inches. At the other end of the size scale, there are a number of smaller devices, such as tablet computers, which fall below the diagonal size used by some laptop computers. As a result, the ability to adjust the position of the restraints not only allows a single lapboard configuration to be sold to individuals having different size laptops, it also allows the same lapboard to be used by a single individual who may have multiple device types.

In the preferred embodiment, there is a proximal wall on the edge of the lapboard closest to the user that prevents the laptop computer from sliding off of the lapboard toward the user. As a result, the restraints are only needed in the preferred embodiment to prevent lateral movement, and longitudinal movement away from the proximal side of the lapboard

Once a laptop computer is placed on the lapboard, the restraints and moved into place. A variety of locking devices may be used to secure the restraints. For example, the restraints may use a locking mechanism based on levers, based on thumbscrews, based on button locks, etc. The only requirement is that the locking mechanism securely positions the restraints. Locking mechanisms such as those used herein are well known in the art.

The restraints can also be implemented in a variety of ways. There can be a central slot that allows the restraints to grasp the laptop computer on its lateral edges such that it has sufficient pressure to prevent lateral or longitudinal movement of the laptop. However, the preferred embodiment envisions restraints that engage the lateral edges of the laptop, and in addition, engage the distal edge of the laptop.

Those skilled in the art will recognize that any suitable material can be used to fabricate the lapboard, such as wood, metal, plastic, etc.

Having discussed the invention in general, we turn now to a detailed discussion of the drawings.

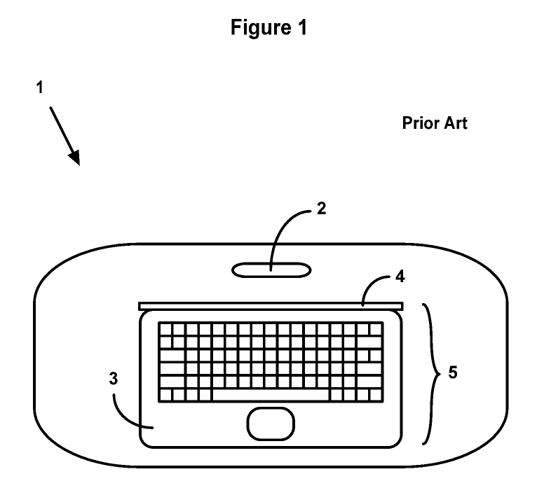

Regarding FIG. 1, this figure illustrates a prior art lapboard 1. Typically, lapboards 1 provide a flat upper surface upon which rests a laptop computer 5. As illustrated in this figure, laptop computer 5 has a lower section 3, and an upper display section 4. As can be seen in this illustration, conventional lapboards 1 do not provide any method of securing a laptop computer 5 from moving either in a longitudinal or lateral direction when the lapboard 1 is moved or tilted.

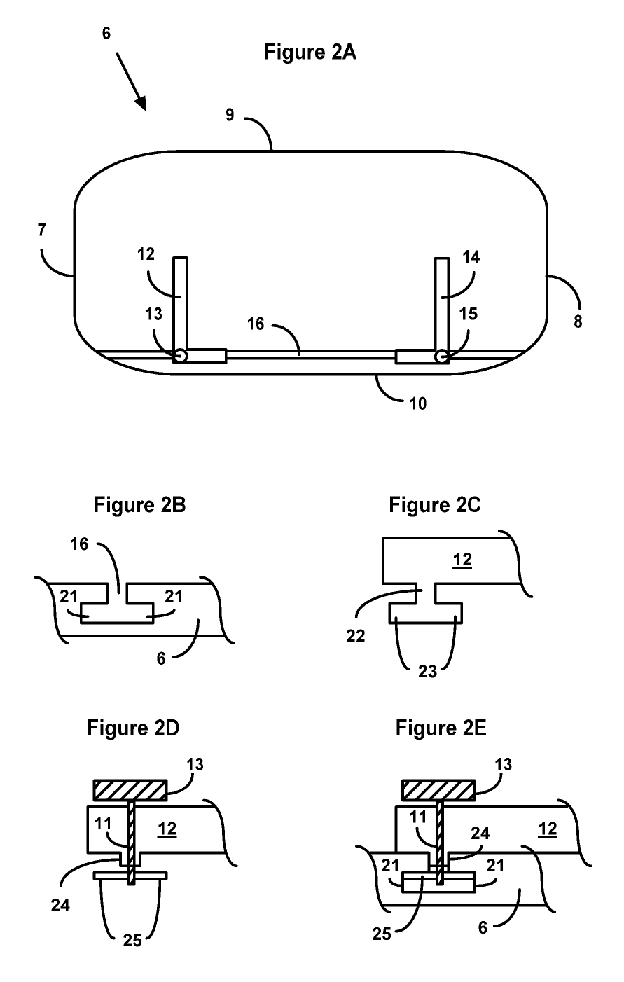

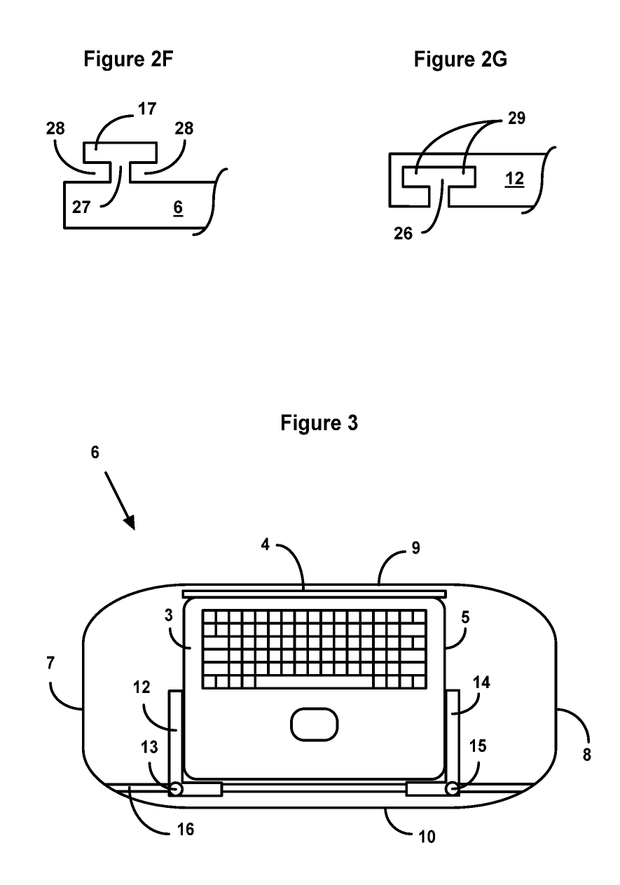

FIG. 2A is a top plan view of a preferred embodiment of the adjustable lapboard 6 in which the lapboard 6 has a distal longitudinal edge 9, an opposing proximal longitudinal edge 10, a first lateral edge 7, and a second lateral edge 8. Slot 16 provides a slot 16 along which restraints 12, 14 slide laterally. Once the laptop 5 is placed on the surface of lapboard 6, the restraints 12, 14 are moved in position to rest against the sides of the laptop 6. Optional locking mechanisms 13, 15 are engaged to secure the restraints 12, 14 in position. As noted above, locking mechanisms 13, 15 can be any suitable mechanism such as a thumbwheel, a button, a lever, etc.

FIG. 2B is a side end view of a portion of lapboard 6 further illustrating the slot 16 along with lateral slot extensions 21. Of course, a single lateral slot extension 21 can be used, but opposing lateral slot extensions 21 provide better stability when the restraints 12, 14 are secured to the lapboard 6.

FIG. 2C is a side view of a portion of a restraint 12 illustrating the slot key 22 and the key extensions 23 that fit inside of the slot 16 and lateral slot extensions 21. When the slot key 22 is inserted into slot 16, the key extensions 23 fit within lateral slot extensions 21. Lateral key extensions 23 prevent restraint 12 from disengaging from lapboard 6. Further, in the preferred embodiment, slot key 22 is sized to snugly and slidably fit in slot 16 such that it is held in place via locking mechanisms 13, 15, or alternatively, it is secured via frictional engagement.

FIG. 2D is an alternative preferred embodiment of a restraint 12. It is a side view of a portion of a restraint illustrating an adjustable slot key 11 that fits inside of the slot 16 and lateral locking extensions 25 and is held via a threaded adjustable locking mechanism 13. Channel 24 provides a path for slot key 11 to extend from the locking mechanism 13 to the lateral locking extensions 25.

The lapboard 6 of the present invention can be fabricated in any suitable size. Preferably, the lapboard 6 will have sufficient size to accommodate a wide variety of laptop computers and other electronic devices. In addition, another preferred embodiment envisions the lapboard 6 having a size suitable for fitting within a backpack (not shown). Backpacks are well known in the art. The advantage of providing a lapboard 6 that will fit within a backpack is that a great many students and/or travelers use backpacks to carry their computers with them when they travel. It would be desirable to have a lapboard 6 that can fit within the backpack along with their computer 5 (or other electronic devices) to provide students and travelers with the convenience of having a lapboard 6 available when they want to use it. It is even envisioned that the lapboard 6 of the present invention would be sold as a package along with backpacks.

FIG. 2E is a side view of a portion of a restraint 12 showing the slot key 11 inserted inside the lateral slot extensions 21 of slot 16 and held via a locking mechanism 13. When the restraint 12 is inserted into lapboard 6, the locking mechanism 13 is rotated, which in turn rotates threaded slot key 11. As threaded slot key 11 rotates, it moves lateral locking extensions 25 into contact with the top of lateral slot extensions 21. Once engaged, the restraint 12 is prevented from moving.

FIG. 2F is a side view of another alternative preferred embodiment of the lapboard 6 in which a raised rail 17 on the surface of the lapboard 6 replaces the slot 16 in the previous embodiments. In this embodiment, the rail 17 is supported by post 27. On either side of post 27 are rail channels 28.

FIG. 2G is a side view of another alternative preferred embodiment of the restraint 12 in which a restraint channel 26 in the restraint 12 is sized to slidably fit on the rail 17. Restraint channel extensions 29 are sized to sildably fit over raised rail 17.

Those skilled in the art will recognize that the same type of locking mechanisms used in the other embodiments of this invention can be used in this embodiment.

FIG. 3 is the top plan view of the lapboard 6, shown in FIG. 2, in which the laptop computer 5 is placed into position and secured. Likewise, the restraints 12, 14 prevent the laptop 5 from sliding off of the distal longitudinal edge 10 or sliding laterally off of the first or second lateral edges 7, 8. Once secured by locking mechanisms 13, 15, the laptop 5 is safely secured to lapboard 6.

In this figure, the restraints are shown mounted to a slot 16. Those skilled in the art will recognize that slot 16 can alternatively be a ridge that extends outward from the surface of lapboard 6. When a ridge is used, it can be placed at any desirable location, including the proximal longitudinal edge 10.

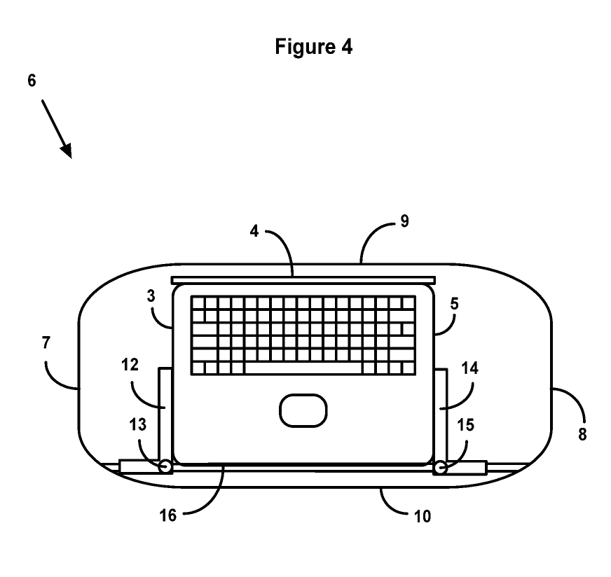

FIG. 4 illustrates an alternative preferred embodiment of the lapboard 6 in which the restraints 12, 14 are reversed in orientation.

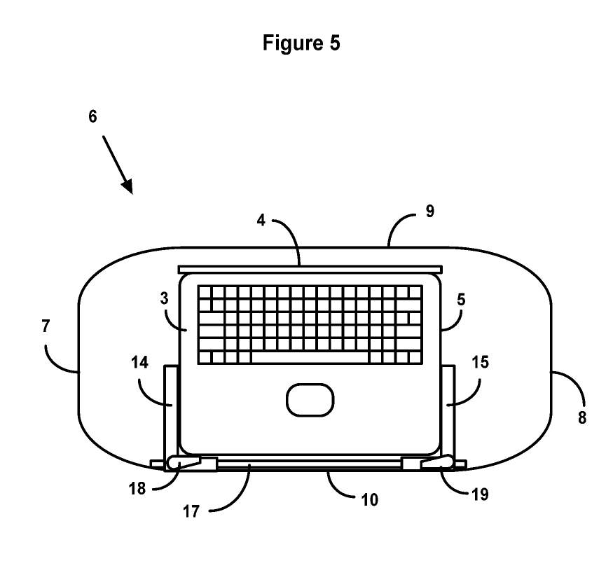

FIG. 5 shows a top view of yet another preferred embodiment of the invention in which the slot 16 is replaced by rail 17, and the thumbwheels that were used by the locking mechanism 13, 15 that were shown in the previous embodiments have been replaced by levers 18, 19.

When using the rail 17, the locking mechanisms 18, 19 can be eliminated. An alternative to using a locking mechanism 18, 19 would be to adhere a layer of hook and loop material to the top surface of the rail 17 and adhere a corresponding layer of hook and loop material to the inner surface of restraints 14, 15. The restraint shaped to slidably fit over the rail 17 and having an inner surface that corresponds to the top surface of the rail 17.

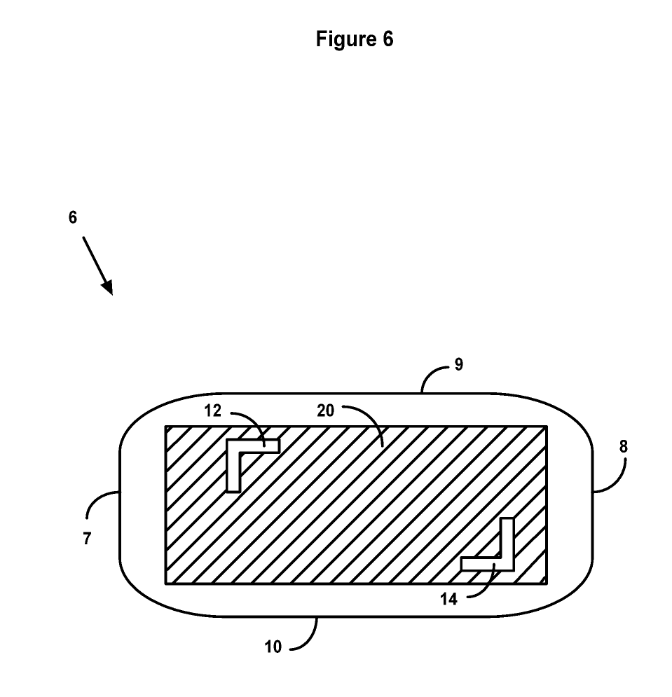

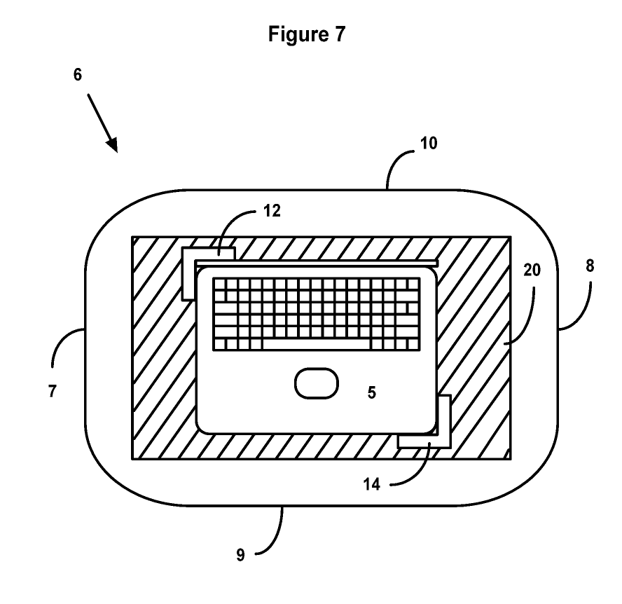

FIG. 6 shows a top plan view of yet another preferred embodiment of the invention in which the upper surface of the lapboard 6 is at least partially covered by hook and loop material 20. The restraints 12, 14 have matching hook and loop material 20 on the bottom surface. As a result, a laptop computer 5 can be placed anywhere on the surface of the lapboard 6 and secured in place by the restraints 12, 14. Those skilled in the art will recognize that while it is possible to use four restraints 12, 14, only two restraints 12, 14 are necessary, because when placed on opposing corners, a laptop computer 5 will be prevented from rotating. Of course, it is always possible to use four restraints 12, 14 for aesthetic reasons.

For ease of illustration, this figure shows the surface area covered by the hook and loop material 20 to be less than the surface area of lapboard 6. However, those skilled in the art will recognize that the entire surface of lapboard 6 can be covered by hook and loop material 20. As a result, this embodiment provides the greatest flexibility for a given lapboard 6 size.

FIG. 7 is a top plan view of the alternative preferred embodiment of FIG. 6 that shows a laptop computer secured to the lapboard 5. In this embodiment, the user merely places the laptop in any convenient place on the surface of the hook and loop material 20. Then, the user places restraints 12, 14 on opposing corners of the laptop computer 5. By using L-shaped restraints, a laptop computer 5 has prevented from rotating and/or sliding on the lapboard 6.

An advantage associated with this embodiment is that the lapboard can be manufactured much less expensively because of the reduction in parts. For example, the locking mechanisms on the restraints 12, 14 have been eliminated, and the slot 16 or rail 17, as well as the distal longitudinal edge 10 have been eliminated. This embodiment contains the least number of required parts.

Further, by attaching the restraints via hook and loop material, any size laptop computer 5 that will fit on the hook and loop material 20 on lapboard 6 can be used with lapboard 6.

A further advantage associated with this embodiment is that a kit can be provided to upgrade existing prior art lapboards 1. All that is required for the kit is a suitably sized supply of hook and loop material for attachment to the surface of the pre-existing lapboard 1 and at least two restraints 12, 14.

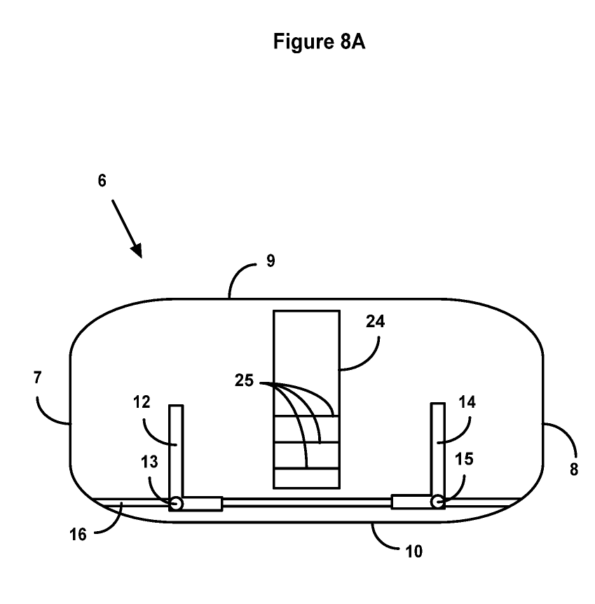

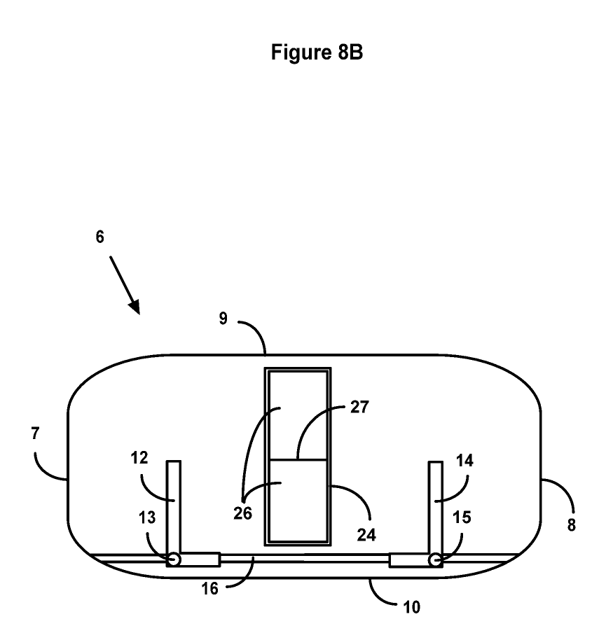

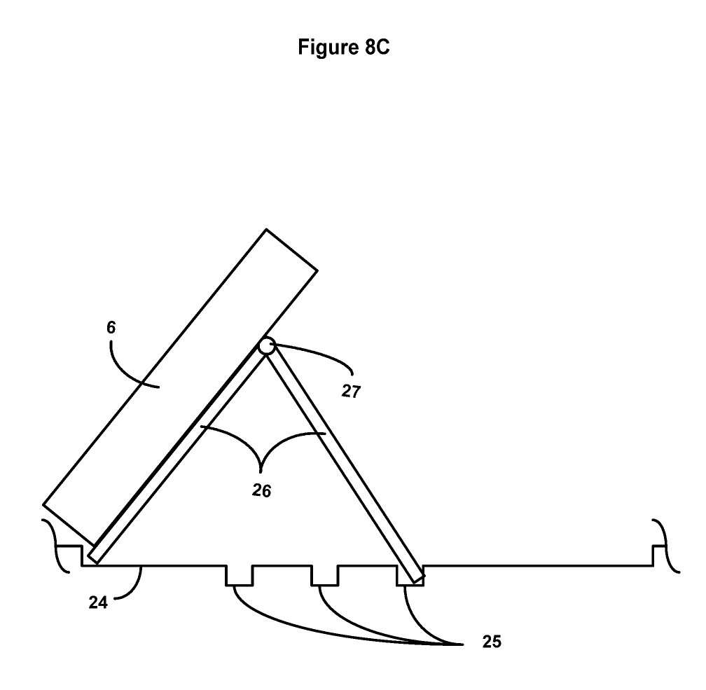

FIG. 8A is a top plan view of alternative preferred embodiment that shows an optional cutout 24 in the surface of lapboard 6 for receiving a tilting bracket 26 (shown in FIGS. 8B and 8C). This embodiment envisions an optional tilting bracket 26 that allows any suitable type of device used with lapboard 6 to be tilted upward at an angle to provide easier viewing for the user. Also shown in this figure are grooves 25. Any desirable number of grooves 25 can be used to allow the tilting bracket 26 (shown in FIG. 8B) to be positioned at different viewing angles.

FIG. 8B illustrates the alternative preferred embodiment of FIG. 8A with the tilting bracket 26 installed and in a flat position. Also shown in this figure is bendable seam 27 that allows tilting bracket 26 to be folded such that it can be secured in a groove 25.

FIG. 8C illustrates a cutaway side view of the alternative preferred embodiment of FIG. 8A with the tilting bracket 26 installed and in a raised position for supporting a computer, electronic device, book, etc. In this figure, a laptop computer 6 is illustrated. However, those skilled in the art will recognize that any electronic device, such as tablet computers, iPads™, smart phones such as iPhones™, handheld devices such as iPods™, e-book readers such as the Kindle™, or electronic games, other devices, or even books or magazines can be tilted upward using the optional tilting bracket 26. Further, the laptop 6 is not limited to electronic devices as it can just as easily used in conjunction with conventional books or magazines. The tilting bracket 26 provided by the invention allows a user to conveniently position the device to the most comfortable viewing angle.

As shown in this figure, the tilting bracket 26 is folded at seam 27, and the end of the tilting bracket 26 is secured in one of the grooves 25. The device, which may be a laptop 6 as shown, or any other suitable device or object.

Those skilled in the art will recognize that the tilting mechanism can be implemented without using the grooves 25. For example, the grooves 25 can be replaced by a hook and loop securing mechanism that would allow even greater control of the tilt angle.

For ease of discussion, the foregoing descriptions have been discussed in terms of a conventional laptop computer 5. However, those skilled in the art will recognize that any electronic device that an individual may want to hold a lapboard 6 can be used in conjunction with this invention. For example, in addition to laptop computers 5, tablet computers such as the Apple iPad™ and others, electronic games, or any other device that is suitable for use with a lapboard.

While specific embodiments have been discussed to illustrate the invention, it will be understood by those skilled in the art that variations in the embodiments can be made without departing from the spirit of the invention. For example, the size and shape of the lapboard can vary, the materials used to construct the lapboard can be anything deemed suitable for a particular design, the structure of the slot or rail can vary, the choice of locking mechanisms can be anything suitable for its purpose, etc. Therefore, the invention shall be limited solely to the scope of the claims.

I claim:

1. An adjustable lapboard for securing an object, comprising:
a lapboard having a surface to support an electronic device;
at least two adjustable restraints, the restraints having positioning means such that, when the object is placed on the surface, the restraints can be moved adjacent to the object to prevent the object from sliding.

2. A lapboard, as in claim 2, wherein:
the object is a laptop computer, tablet computer, smartphone, an electronic game, or a book.

3. A lapboard, as in claim 1, wherein:
the restraints are movably secured to a slot in the surface of the lapboard such that the restraints can be moved toward or away from an object placed on the surface of the lapboard.

4. A lapboard, as in claim 3, wherein:
the slot in the surface of the lapboard extends laterally across the surface of the lapboard such that restraints secured to the slot move laterally in relation to each other.

5. A lapboard, as in claim 4, further comprising:
a slot key extends from the restraint, and is sized to slidably fit within the slot in the surface of the lapboard;
at least one lateral slot extension in the slot under the surface of the lapboard; and
at least one key extension on the slot key that is sized to slidable fit within the lateral slot extension of the slot.

6. A lapboard, as in claim 5, wherein:
the restraint is secured to the slot in the surface of the lapboard via friction.

7. A lapboard, as in claim 5, wherein:
the restraint is secured to the slot in the surface of the lapboard via a locking mechanism.

8. A lapboard, as in claim 1, further comprising:
a rail, extending upward from the surface of the lapboard and laterally across the surface of the lapboard
the restraints are movably secured to the rail such that the restraints can be moved toward or away from an object placed on the surface of the lapboard.

9. A lapboard, as in claim 8, wherein:
the top surface of the rail has a layer of hook and loop material;
the restraint has a an inner surface that corresponds to the top surface of the rail, and has a layer of hook and loop material that corresponds to the layer of hook and loop material on the rail; and
the restraint is secured to the rail on the lapboard via the hook and loop material.

10. A lapboard, as in claim 8, wherein:
the restraint is sized to snugly and slidably fit on the rail such that it is secured to the rail on the lapboard via frictional engagement.

11. A lapboard, as in claim 8, further comprising:
a rail post that extends upward from the lapboard surface and supports the rail, the rail post having a smaller width than the rail such that rail channels are formed on either side of the rail post;
a restraint channel in the restraint which is sized to slidably accept the rail post; and
restraint channel extensions in the restraint sized to slidably accept the rail.

12. A lapboard, as in claim 11, wherein:
the restraint is secured to the rail on the surface of the lapboard via friction.

13. A lapboard, as in claim 11, wherein:
the restraint is secured to the rail on the surface of the lapboard via a locking mechanism.

14. A lapboard, as in claim 1, further comprising:
a layer of hook and loop material secured to at least a portion the upper surface of the lapboard; and
a layer of corresponding hook and loop material secured to the restraint is secured to the lower surface of the restraints, such that when at least two restraints are placed on preselected locations on the lapboard, the restraints are held in place by the hook and loop material;
whereby, the restraints are positioned the surface of the lapboard such that an object mounted on the surface of the lapboard is prevented from slipping.

15. A lapboard, as in claim 1, further comprising:
a cutout in the top surface of the lapboard;
a tilt bracket sized to fit within the cutout; and
means to raise the tilt bracket such that an object placed on the lapboard will be positioned in a raised position for better viewing.

16. A lapboard, as in claim 15, wherein:
the tilt bracket is adjustably attached such that the angle of objects resting on it are adjustable to a plurality of selectable viewing angles.

17. A lapboard, as in claim 16, further comprising:
a seam in the surface of the tilt bracket that allows the tilt bracket to be folded to form a predetermined angle;
at least one groove in the surface of the cutout such that when the tilt bracket is folded, the end of the tilt bracket is secured by placing it in the groove.

18. A method of securing a device to a lapboard, including the step of:
adjustably securing at least two restraints to the surface of a lapboard such that when an object is placed on the surface of the lapboard between the restraints, the object is prevented from inadvertently sliding.

19. A method, as in claim 18, including the additional step of:
securing the restraints to the surface of a lapboard with a lateral slot that the restraints fit into, or with a rail that the restraints attach to.

20. A method, as in claim 18, including the additional step of:
using a tiltable bracket raises up from the surface of the lapboard and adjusts to a plurality of viewing angles;
whereby, the viewing angle for objects placed on the lapboard is adjustable.
